(19) United States
(12) Patent Application Publication
(10) Pub. No.: US 2026/0244738 A1
(43) Pub. Date: Aug. 20, 2026

(54) Single Pane of Glass (SPOG) Visibility for Large-Scale Service Provide Network

(71) Applicant: Ciena Corporation, Hanover, MD (US)

(72) Inventor: Shaiju Cheruvathur Kangu, Ottawa (CA)

(73) Assignee: Ciena Corporation, Hanover, MD (US)

(21) Appl. No.: 19/055,008

(22) Filed: Feb. 17, 2025

(51) Int. Cl. G06F 21/55

(52) U.S. Cl. CPC G06F 21/554; G06F 2221/034

(57) ABSTRACT

Systems and methods described herein are configured to offer network administration and orchestration services to a global service provider. In one implementation, a global administration system includes an input/output device configured to display information to a user, a processing device, and memory configured to store computing logic. The computing logic, for example, has instructions for enabling the processing device to perform steps of 1) receiving data from one or more regional network monitoring systems distributed globally for monitoring multiple domains serviced by one or more service providers of a global service provider network, 2) consolidating the data to create a Single Pane of Glass (SPOG) showing a global view of the global service provider network, and 3) displaying the SPOG on the input/output device.

### FIELD OF THE DISCLOSURE

The present disclosure relates generally to networking and computing. More particularly, the present disclosure relates to systems and methods for providing network orchestration and administration services to a global service provider so as to enable a global operational view using Single Pane of Glass (SPOG) visibility.

### BACKGROUND

Large communications companies may deploy data centers and other communications facilities throughout one or more countries in which they do business. According to one example, a multinational conglomerate operates over 30 data centers. Most of these data centers are located in the United States, while others are located in Asia and Europe. Normally, a company may utilize sophisticated monitoring equipment to monitor and manage a portion of their network on a scale up to about the size of one entire data center. Then, management teams may combine the results of each of these individually monitored data centers to get a picture of how the entire operation is performing on a global scale.

### BRIEF SUMMARY

The present disclosure relates to systems and methods for globally managing multiple service providers of a global service provider network. According to one implementation, a method includes a step of receiving data from one or more regional network monitoring systems distributed globally for monitoring multiple domains serviced by one or more service providers of a global service provider network. Also, the method includes a step of consolidating the data to create a Single Pane of Glass (SPOG) showing a global view of the global service provider network. Next, the method includes a step of displaying the SPOG on a display screen of a global administrator device. In some embodiments, the method may be executed by a global administration system that has an input/output device, a processing device, and memory, wherein the memory stores computing logic having instructions for enabling the processing device to perform the steps of the method.

According to some embodiments, the SPOG may be configured as a User Interface (UI) or dashboard allowing a user of the global administrator device (or global administration system) to have end-to-end global visibility into enterprise-wide sources of data. In some embodiments, the method may permit the user to utilize the SPOG to gain federated control over the domains and services of the global service provider network. Also, each regional network monitoring system may be configured to obtain data by monitoring one or more Network Elements (NEs) included within each of the multiple domains. In some implementations, the one or more service providers may share multiple resources and may be separately managed. The global administration system (or device) may be a service orchestration system configured in a Network Operations Center (NOC) or Network Management System (NMS).

In some embodiments, the global administration systems and methods may implement one or more abstraction layers associated with the one or more service providers. For example, each of the one or more abstraction layers may be configured to separate and hide details of a network management system or local network monitoring system with respect to a corresponding regional network monitoring system. Also, the one or more abstraction layers may be associated with the one or more service providers, wherein the one or more abstraction layers may be configured to interact between multiple different service providers for providing security between the multiple different service providers and to maintain a global instance for managing the global service provider network.

The global administration systems and methods described herein and as associated with the method may further include multiple domain controllers distributed within the multiple domains. The multiple domain controllers, for example, may be configured to interact with each other and modify configuration settings of one or more NEs within each domain. Also, the global service provider network may include a mix of terrestrial equipment and submarine equipment, where the submarine equipment may include one or more of a Submarine Line Terminal (SLT), a Point of Presence (PoP) device, a Cable Landing Station (CLS), and a third-party wet plant controller. The global service provider network, in some cases, may include Network Elements (NEs) configured within the multiple domains in Layer 0 (photonic layer), Layer 1 (physical layer), Layer 2 (data link layer), and Layer 3 (network layer) of the OSI network architecture model. Furthermore, the data described herein may include one or more of Generalized Signal to Noise Ratio (GSNR) data, Effective Signal to Noise Ratio (ESNR) data, Forward Error Correction (FEC) data, Bit Error Rate (BER) data, and High Correction Count Seconds (HCCS) data.

According to some embodiments, the method may be associated with a global administration system in which the one or more service providers include one or more cloud providers, hyperscalers, and carriers having worldwide-expanded networks. The one or more service providers, for example, may include multiple service providers that are independently and privately owned and managed. The one or more regional network monitoring systems, in some embodiments, may be configured to communicate within the global administration system using one or more of a Transport Application Programming Interface (T-API) model, a RESTCONF model, and a NETCONF model. The one or more service providers may also be configured to manage Fault, Configuration, Accounting, Performance, and Security (FCAPS) aspects of the multiple domains. The SPOG, for instance, may be configured to provide one or more of a topology view, a service view, performance analysis, alarms, and inventory information of the multiple domains.

### BRIEF DESCRIPTION OF THE DRAWINGS

The present disclosure is detailed through various drawings, where like components or steps are indicated by identical reference numbers for clarity and consistency.

FIG. 1 is a network diagram illustrating an administration system, according to various embodiments.

FIG. 2 is a network diagram illustrating a subsea control system, according to various embodiments.

FIG. 3 is a network diagram illustrating a regional administration system, according to various embodiments.

FIG. 4 is a network diagram illustrating a global managing system, according to various embodiments.

FIG. 5 is a network diagram illustrating another global administration system, according to various embodiments.

FIG. 6 is a network diagram illustrating a flow through an administration system, according to various embodiments.

FIG. 7 is a network diagram illustrating a global instance for managing multiple regional instances, according to various embodiments.

FIG. 8 is a network diagram illustrating a global administration system for managing a large-scale service provider, according to various embodiments.

FIG. 9 is a block diagram illustrating a computer system of a global administration system, according to various embodiments.

FIG. 10 is a screenshot showing a Single Pane of Glass (SPOG) on a global administration system, according to various embodiments.

FIG. 11 is a flow diagram illustrating a method for globally managing a service provider, according to various embodiments.

### DETAILED DESCRIPTION

Complex network monitoring systems are used for observing the performance of network equipment and responsively managing network configurations as needed to enable the networks to perform optimally. These administrative systems are usually limited to a single data center, node, regions, etc. However, companies that operate in multiple locations might usually attempt to gather network data from these multiple locations or nodes and manage them independently. Conventional systems are unable to provide an overall picture of the performance of the entire network of the company. To overcome the limitations of the conventional systems, the systems and methods of the present disclosure are configured to consolidate network metrics from multiple regions, nodes, data centers, etc. and provide a Single Pane of Glass (SPOG) (e.g., dashboard, User Interface (UI), Graphical User Interface (GUI), etc.) that shows a representation of the entire system.

Today's networks are not confined to one geographic region, but they may span across several regions globally interconnecting users and systems to meet the objectives of an enterprise. Networks can be a mix of terrestrial, subsea, and the Data Communications Network (DCN) required to connect and manage these networks. The networks can also be differentiated as directly managed by an enterprise or can be configured in a mode for management or administration of a network (e.g., optical fiber network). There are numerous challenges involved in managing and monitoring global networks, such as data isolation, regulatory, and data sovereignty. The present disclosure is directed to providing an innovative network monitoring architecture to interconnect terrestrial and subsea networks in a SPOG view from a global end-to-end perspective. Additionally, the present disclosure is configured to enable increased automation to reduce operational expenses and increase velocity in network monitoring for enterprise needs.

### General Administration System

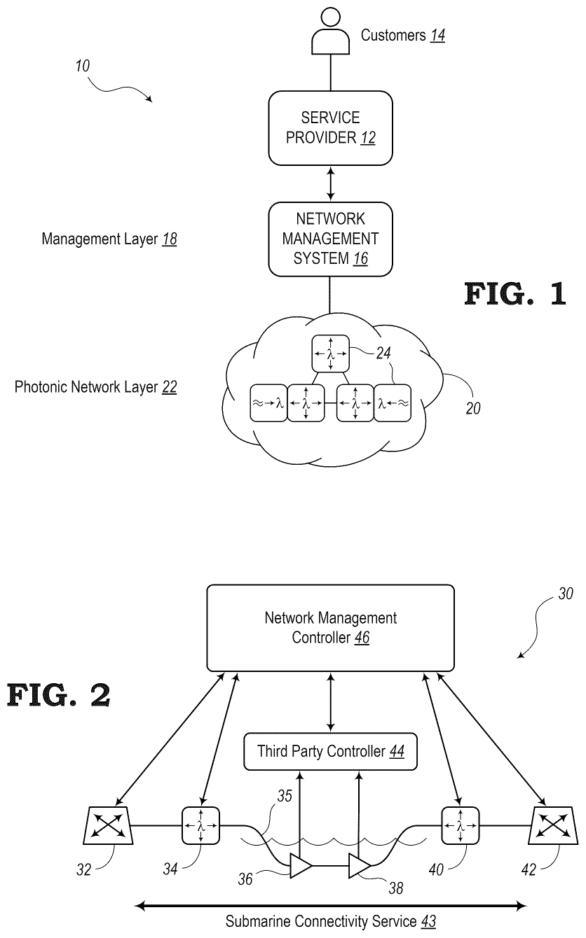

FIG. 1 shows an embodiment of an administration system 10 for monitoring and controlling various aspects of a large-scale network, such as a network associated with a large service provider. As shown in FIG. 1, the administration system 10 includes a service provider 12 configured to provide services (e.g., Internet access, etc.) to a number of customers 14. Also, the administration system 10 includes a network management system 16 that is implemented in a management layer 18. The network management system 16 is configured to monitor and control a domain 20 (or sub-network) implemented in a photonic network layer 22. As shown, the domain 20 may include a number of Network Elements (NEs) 24, such as switches, routers, amplifiers, Reconfigurable Optical Add/Drop Multiplexers (ROADMs), Wavelength-Divisional Multiplexing (WDM) devices, etc.

In some embodiments, the service provider 12 may be a Communications Service Provider (CSP). The CSPs may be configured in some cases to sell managed 100G wave services to global content providing network operators, such as “hyperscalers.” The network management system 16 may use open APIs to access Operational Support Systems (OSSs). The photonic network layer 22 may be configured as a Content Distribution Network (CDN). Display of network performance details may include a) a topology view, b) a service view, c) a performance analysis view, d) alarms, e) inventory, f) service provisioning, etc.

Servicing the service providers or hyperscalers may include certain operational challenges in some cases. For example, a managed network may need service provider permission to access a network. Also, filtered information may be accessed through the service provider. In some cases, there may be no real-time network updates or information. Also, there may be no standardized format for data sharing. Other challenges related to the service providers and/or carriers may include no direct access to management control services. Also, there may be fear that service provider of carrier network information is leaked. Other issues may include runtime user creation access and control of rights or data flow. In some implementations, each service provider may include a service provider network and a global network, managed by a specific administration systems, such as those described in the present disclosure.

Administration services may include a) element management, b) network management, c) software domain control, and d) advance workflow platforms. These may be implemented in software within an administrator computing system. The element management may include a framework for network management that categorizes network management tasks into Fault, Configuration, Accounting, Performance, and Security (FCAPS), as described in the International Organization for Standardization (ISO) FCAPS model. For instance, fault management tasks include identifying and resolving network issues. Configuration management tasks include managing network settings and devices. Accounting management tasks include tracking network usage and resources. Performance management tasks include monitoring and enhancing network speed and reliability. Security management tasks include protecting the network from threats and vulnerabilities.

### Subsea System

FIG. 2 shows an embodiment of a subsea control system 30. According to the illustrated embodiment, the subsea control system 30 includes a first Point of Presence (PoP) device 32, where network traffic may be exchanged from a land-based service provider to a sea-based service provider. The subsea control system 30 further includes a first Cable Landing Station (CLS) 34, which represents a land facility where submarine fiber optic cable comes ashore. The first PoP device 32 and first CLS 34 may use 1+1 trunk protection and may be part of Submarine Line Terminal (SLT) equipment that terminates optical signals from subsea cables to allow them to be transferred to land-based networks.

Subsea optical fiber cables 35 are passed through a third party wet plant, which includes amplifiers 36, 38, which are configured to boost attenuated optical signals travelling over great lengths. On the other end of the subsea optical cables 35, the line system includes a second CLS 40 and a second PoP device 42, which may be configured for shared mesh restoration. The first PoP device 32, first CLS 34, subsea optical fiber cables 35, amplifiers 36, 38, second CLS 40, and second PoP device 42 constitute a submarine connectivity service 43 that enables propagation of photonic signals over long distances, including travel through submarine line systems (e.g., from one country or continent to another). The submarine connectivity service 43 may be maintained and managed by a third party wet-plant company (e.g., SubCom, Alcatel Submarine Networks (ASN), Nippon Electric Company (NEC), etc.). The subsea optical fiber cables 35 and amplifiers 36, 38 may also be owned by third party company. In addition, the subsea control system 30 includes the use of a third party controller 44 (e.g., owned and controlled by the third party).

Furthermore, the subsea control system 30 of the present disclosure may include a network management controller 46, which is configured to communicate with the third party controller 44 (e.g., using open config protocols) and obtain information retrieved by this device. The network management controller 46 also obtains information from the PoP devices 32, 42 and CLSs 34, 40 via RESTCONF and/or YANG protocols.

A large-scale service provider may wish to consult the network management controller 46 to get an overall view of the submarine connectivity service 43. As such, the network management controller 46 may be configured to provide a monitoring, managing, and administration service to the large-scale service providers, who in turn provide a service (e.g., Internet access) to a number of customers. From the network management controller 46, a dashboard or SPOG may be used to provide the third party with a view of their systems. Also, in some embodiments, the network management controller 46 may be further configured to control various parts of the line system for rerouting packets, modifying amplifier power, measuring, testing, etc. This may allow a network operator of the third party to view network activity from one transporter to the other, even including the wet plant. One goal, therefore, may be to manage cumulative services that are running from end-to-end (e.g., PoP to PoP), which allows a more comprehensive approach as compared to the conventional systems where each portion may be managed separately. An example of network management, if it is detected that a repeater goes down, which would impact both internal customers and external customers, the status of the equipment (e.g., repeater) can be seen in the SPOG.

Therefore, multiple nodes, data centers, submarine connectivity lines, terrestrial optical lines, etc. may be deployed and integrated as one. Thus, by viewing the entire network architecture as a single system, the systems and methods of the present disclosure are configured to monitor the overall system and present the status of the system throughout the world. Another aspect of the end-to-end monitoring and control, the administration systems of the present disclosure are further configured to view portions of the network, including a Photonic Layer (i.e., Layer 0), a Physical Layer (i.e., Layer 1), a Data Link Layer (i.e., Layer 2), and a Network Layer (i.e., Layer 3). These layers of the network can be observed, tested, monitored, etc. for analyzing and detecting the status of the NEs throughout the network.

### Regional Monitoring

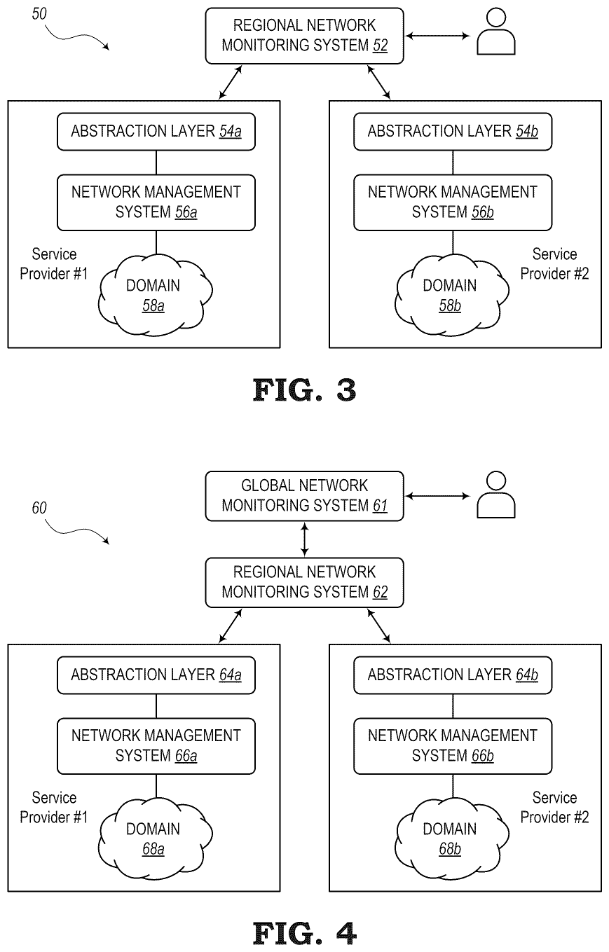

FIG. 3 shows an embodiment of a regional administration system 50. As shown in the embodiment of FIG. 3, the regional administration system 50 includes a regional network monitoring system 52 configured to provide Performance Monitoring (PM) data and other network status information to customers (e.g., large-scale service providers, global CSPs, hyperscalers, etc.). The regional administration system 50 includes monitoring services for two different service providers (e.g., Service Provider #1 and Service Provider #2). The results of monitoring the service providers #1 and #2 can be passed to the customers as needed for display on a SPOG or other UI-based screens.

Within Service Provider #1, an abstraction layer 54a is deployed for acting as an intermediary between the service provider and the regional network monitoring system 52. The Service Provider #1 also includes a network management system 56a, which is configured to monitor and control NEs of a domain 58a. Similarly, Service Provider #2 includes an abstraction layer 54b deployed therein for acting as an intermediary between the service provider and the regional network monitoring system 52. The Service Provider #2 also includes a network management system 56b, which is configured to monitor and control NEs of a domain 58b. For example, each of the abstraction layers 54a, 54b may be a gateway component that separates and simplifies the complexities of the network management systems 56a, 56b by hiding details thereof from the regional network monitoring system 52. Also, the abstraction layers 54a, 54b are configured to represent the network management systems 56a, 56b with a higher-level view for simplifying the visualization of the global network.

In some embodiments, the regional network monitoring system 52 may be arranged in a cloud-based environment and/or may be configured in a Network Operations Center (NOC), Network Monitoring System (NMS), or the like. The regional network monitoring system 52 may be configured to communicate with the abstraction layers 54a, 54 b via a Transport API (T-API). For example, T-API (e.g., T-API 2.0) may be configured as a standardized interface, released in late 2017 by the Open Networking Foundation (ONF), enabling the dynamic allocation of transport resources using Software-Defined Networking (SDN) technology. The interface of the T-API may be configured such that, when a service provider (or one of its customers) requests a service, the associated resources including the underlying transport are configured promptly.

According to some implementations, the regional network monitoring system 52 may be configured to provide a number of output data to the customers or clients for SPOG display. The data may include a) a topology view, b) a service view, c) performance analysis, d) alarms (read only), and e) inventory information. However, there might be no provisioning. In this way, the regional network monitoring system 52 may be limited or restricted in terms of the changes it can make to the domains 58a, 58b. On the other hand, the network management systems 56a, 56b may provide the same data of a) a topology view, b) a service view, c) performance analysis, d) alarms, and e) inventory information, while also providing f) service provisioning.

The abstraction layers 54a, 54b may be implemented on a service layer in accordance with the systems and methods described in the present disclosure. The network management systems 56a, 56b may be implemented in a management layer and may be referred to as domain controllers, namely each of the network management systems 56a, 56b are configured to control the respective domains 58a, 58b. For example, the domain controllers are configured to modify configuration settings of one or more network elements within each domain 58a, 58b. Also, the domains 58a, 58b (and accompanying NEs) may be implemented in the photonic network layer.

### Global Monitoring Systems

FIG. 4 shows an embodiment of a global administration system 60, which may be considered to be an extension of the regional-based system shown in FIG. 3. The global administration system 60 includes a global network monitoring system 61 configured in communication with a regional network monitoring system 62, which may have the same or similar functionality as the regional network monitoring system 52 shown in FIG. 3. Also, the global administration system 60 may include multiple service providers, which may also be the same as or similar to the service providers shown in FIG. 3. That is, the Service Providers #1 and #2, respectively, may include an abstraction layer 64a, 64b, network management system 66a, 66b, and a domain 68a, 68b. Data with respect to regional analysis may be provided from the regional network monitoring system 62 to the global network monitoring system 61 for providing data such as performance monitoring (PM) data, network status, etc. to a SPOG displayed on an input/output device of a computing system associated with network administrator, technician, etc.

Also, communication between the global network monitoring system 61 and the regional network monitoring system 62 may include T-API. Likewise, communication between the regional network monitoring system 62 and the abstraction layers 64a, 64b may also include T-API. Furthermore, the regional network monitoring system 62 may be configured to provide a number of output data to the global network monitoring system 61 to be passed on to the customers or clients for SPOG display. Again, the data at this point may include a) a topology view, b) a service view, c) performance analysis, d) alarms (read only), and e) inventory information, with no provisioning. In this way, the regional network monitoring system 62 may be limited or restricted in terms of the changes it can make to the domains 68a, 68b. The network management systems 66a, 66b may provide the following data elements: a) a topology view, b) a service view, c) performance analysis, d) alarms, e) inventory information, and f) service provisioning.

The abstraction layers 64a, 64b may be implemented in a service layer in accordance with the systems and methods described in the present disclosure. The network management systems 66a, 66b may be implemented in a management layer and may be referred to as domain controllers, namely each of the network management systems 66a, 66b are configured to control the respective domains 68a, 68b. For example, the domain controllers are configured to modify configuration settings of one or more network elements within each domain 68a, 68b. Also, the domains 68a, 68b (and accompanying NEs) may be implemented in the photonic network layer.

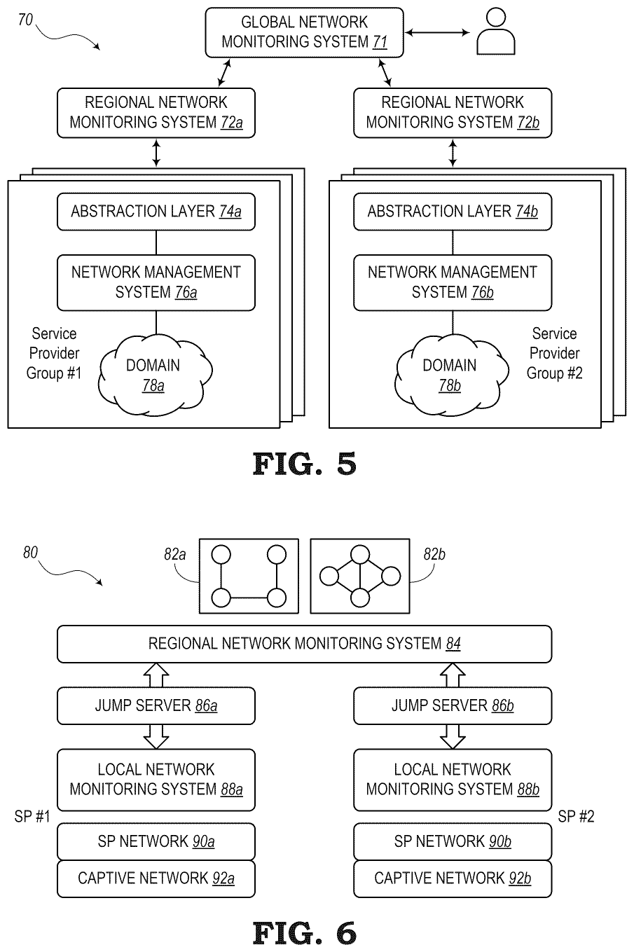

FIG. 5 shows another embodiment of a global administration system 70. In this embodiment, a global network monitoring system 71 is configured to receive data, etc. from multiple regional network monitoring systems 72a, 72b. As shown, each regional network monitoring system 72a, 72b is configured to monitor multiple service providers, labelled as Service Provider Group #1 and Service Provider Group #2. Each service provider or each service provider group (similar to the embodiment of FIG. 4) includes an abstraction layer 74a, 74b, network management system 76a, 76b, and a domain 78a, 78b. Each regional network monitoring system 72a, 72b may be configured to work with any number of service providers in their respective group.

The abstraction layers 74a, 74b may be implemented on a service layer in accordance with the systems and methods described in the present disclosure. The network management systems 76a, 76b may be implemented in a management layer. Also, the domains 78a, 78b (and accompanying NEs) may be implemented in the photonic network layer.

### Network Flow

FIG. 6 shows an embodiment of a network flow through an administration system 80. Service provider networks 82a, 82b (e.g., hyperscaler networks, etc.) may include various combinations of nodes or NEs. A regional network monitoring system 84 may include the same or similar functions as the regional network monitoring systems 52, 62, 72a, 72b as described in FIGS. 3-5. The administration system 80 may include first and second paths for first and second Service Providers (SP #1 and SP #2). The paths associated with SP #1 and SP #2 include jump servers 86a, 86b, which may be configured as a secure computer that allows users to connect to one network and then “jump” to another network. For example, the jump servers 86a, 86b may be devices placed between a user's device and target hosts and therefore may be configured to span two security zones by providing a secure channel for traffic to flow through firewalls.

The administration system 80 further includes local network monitoring systems 88a, 88b associated with the respective service providers. Each service provider (i.e., SP #1 and SP #2) further includes a Service Provider (SP) network 90a, 90b and a captive network 92a, 92b. For example, the captive networks 92a, 92b may include a Wi-Fi network operated by an Internet Service Provider (ISP) that requires users to go through a login process on a web page (i.e., “captive portal”) before gaining full access to the Internet. This may be done, for example, by entering credentials or agreeing to certain terms and conditions, essentially restricting access to only authorized users.

In some embodiments, the SP networks 90a, 90b may be configured as hyperscaler networks, which may be defined in some cases as Cloud Service Providers that offer computing power and infrastructure to support large-scale applications. In one example, the hyperscaler networks may be associated with large service companies,

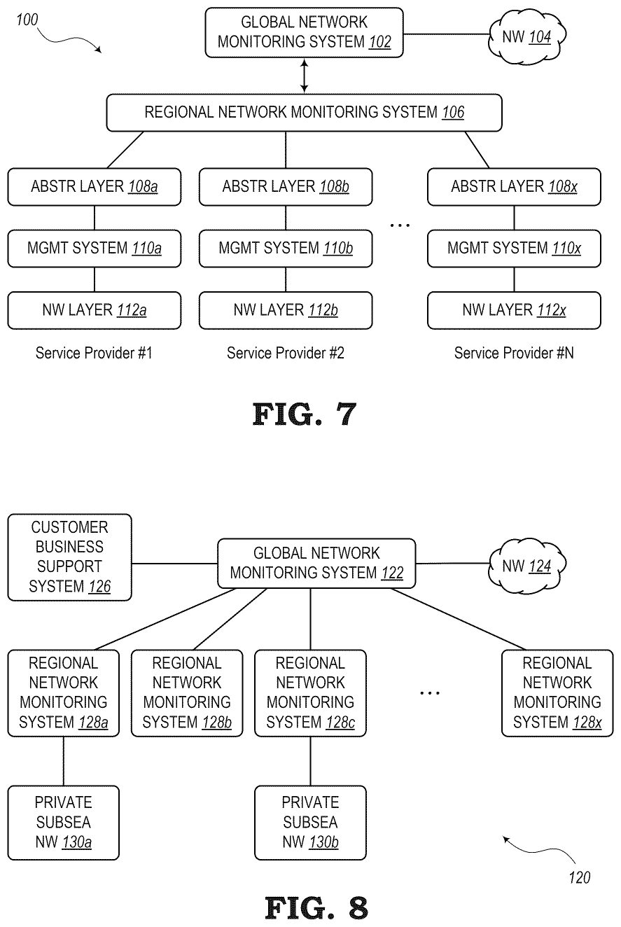

FIG. 7 shows an embodiment of a system 100 including a global instance for managing multiple regional instances. The system 100 includes a global network monitoring system 102 configured for monitoring a network 104. The system 100 also includes a regional network monitoring system 106, which may be a centralized component for servicing multiple service provider networks #1- #N. Each service provider in this embodiment includes an abstraction layer 108a, 108b, . . . , 108x, a management system 110a, 110b, . . . , 110x, and a network layer 112a, 112b, . . . , 112x.

The global network monitoring system 102 may include a control instance acting as a global Operational Support System (OSS) for managing multiple regional instances. The regional network monitoring system 106 may be configured as a multi-layer controller acting as a regional OSS instance. The abstraction layers 108a, 108b, . . . , 108x m are configured to provide an optional service layer for customization of client needs. The abstraction layers 108a, 108b, . . . , 108x may be configured to obtain PM data, inventory, alarms, configs, etc.

FIG. 8 shows an embodiment of a global administration system 120 for managing a large-scale service provider. As illustrated in this embodiment, the global administration system 120 includes a global network monitoring system 122 configured for monitoring a network 124, which may be associated with following a customer Business Support System (BSS) 126. In some embodiments, the network 124 may include subsea transmission (e.g., as described with respect to FIG. 2). Thus, the global network monitoring system 122 may operate with the network management controller 46 of a specific submarine connectivity service, which may be associated with third party provider (e.g., SubCom, ASN, NEC, or other private company that owns and maintains subsea cables).

The global administration system 120 further includes a plurality of regional network monitoring systems 128a, 128b, 128c, . . . , 128x. According to one example, the regional network monitoring systems 128a, 128b, 128c, . . . , 128x may include data centers, nodes, etc. in India, Asia Pacific Accreditation Cooperation (APAC), the Middle East, Africa, and Canadian Association for Laboratory Accreditation (CALA). Some of the regional network monitoring systems 128 may include open config connection to open cable controllers associated with the various third parties (e.g., SubCom, ASN, NEC, etc.) or private subsea networks 130a, 130b.

### Computing System of Global Administrator

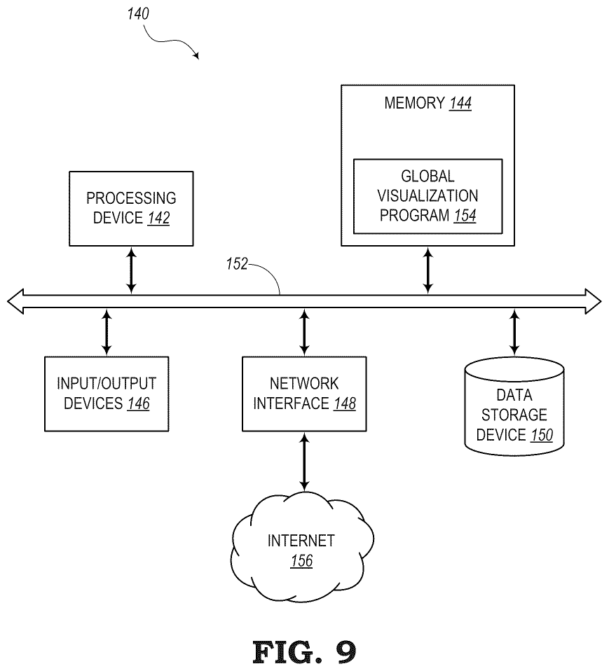

FIG. 9 is a block diagram illustrating a computer system 140 of a global administration system, which may be operated by any network executive, administrator, technician, IT person, engineer, etc. for providing global monitoring and control of a specific service provider network. The computer system 140 includes a processing device 142, memory 144, input/output devices 146, network interface 148, and a data storage device 150, each interconnected with each other via a local bus interface 152. The network interface 148 may be configured for connection with the Internet 156 to enable cloud-base services to customers while also receiving global data for display on a Single Pane of Glass (SPOG) or UI of one of the input/output devices 146, such as a display screen, computer monitor, or the like.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

In particular, the computer system 140 further includes a global visualization program 154, which may be implemented in any suitable combination of hardware (e.g., in the processing device 142) and/or software (e.g., in the memory 144). The global visualization program 154 may be configured in non-transitory computer-readable media and may include logic code or instructions that enable or cause the processing device 142 to perform certain functions as described in the present disclosure.

### Example of a Single Pane of Glass (SPOG)

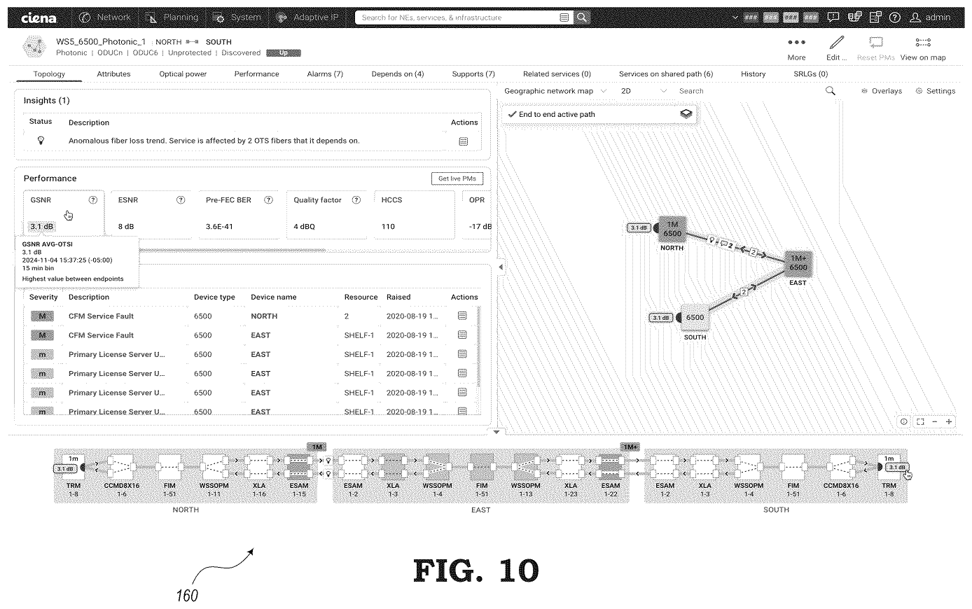

FIG. 10 is a screenshot 160 showing an example of a Single Pane of Glass (SPOG) on a global administration system. For instance, the screenshot 160 of the SPOG may be displayed on any suitable monitor, screen, display device, etc. (e.g., input/output device 146 of the computer system 140 of FIG. 9). In this sense, a network operator (e.g., admin, technician, etc.) can view an overall network status with data in a single image. By providing the entire global network in one screen, a user can easily see how the multiple regional aspects of the network are operating.

### Global Monitoring and Control Method

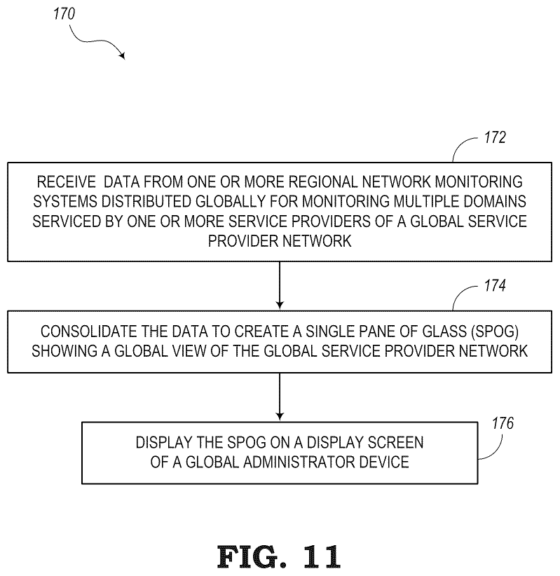

FIG. 11 is a flow diagram illustrating an embodiment of a method 170 for globally managing multiple service providers of a global service provider network. As shown, the method 170 includes a step of receiving data from one or more regional network monitoring systems distributed globally for monitoring multiple domains serviced by one or more service providers of a global service provider network, as indicated in block 172. Also, the method 170 includes a step of consolidating the data to create a Single Pane of Glass (SPOG) showing a global view of the global service provider network, as indicated in block 174. Next, the method 170 includes a step of displaying the SPOG on a display screen of a global administrator device, as indicated in block 176. In some embodiments, the method 170 may be executed by a global administration system that has an input/output device, a processing device, and memory, wherein the memory stores computing logic having instructions for enabling the processing device to perform the steps of the method 170.

According to some embodiments, the SPOG may be configured as a User Interface (UI) or dashboard allowing a user of the global administrator device (or global administration system) to have end-to-end global visibility into enterprise-wide sources of data. In some embodiments, the method 170 may permit the user to utilize the SPOG to gain federated control over the domains and services of the global service provider network. Also, each regional network monitoring system may be configured to obtain data by monitoring one or more Network Elements (NEs) included within each of the multiple domains. In some implementations, the one or more service providers may share multiple resources and may be separately managed. The global administration system (or device) may be a service orchestration system configured in a Network Operations Center (NOC) or Network Management System (NMS).

In some embodiments, the global administration systems and methods may implement one or more abstraction layers associated with the one or more service providers. For example, each of the one or more abstraction layers may be configured to separate and hide details of a network management system or local network monitoring system with respect to a corresponding regional network monitoring system. Also, the one or more abstraction layers may be associated with the one or more service providers, wherein the one or more abstraction layers may be configured to interact between multiple different service providers for providing security between the multiple different service providers and to maintain a global instance for managing the global service provider network.

The global administration systems and methods described herein and as associated with the method 170 may further include multiple domain controllers distributed within the multiple domains. The multiple domain controllers, for example, may be configured to interact with each other and modify configuration settings of one or more NEs within each domain. Also, the global service provider network may include a mix of terrestrial equipment and submarine equipment, where the submarine equipment may include one or more of a Submarine Line Terminal (SLT), a Point of Presence (PoP) device, a Cable Landing Station (CLS), and a third-party wet plant controller. The global service provider network, in some cases, may include Network Elements (NEs) configured within the multiple domains in Layer 0 (photonic layer), Layer 1 (physical layer), Layer 2 (data link layer), and Layer 3 (network layer) of the OSI network architecture model. Furthermore, the PM data described herein may include one or more of Generalized Signal to Noise Ratio (GSNR) data, Effective Signal to Noise Ratio (ESNR) data, Forward Error Correction (FEC) data, Bit Error Rate (BER) data, and other network data.

According to some embodiments, the method 170 may be associated with a global administration system in which the one or more service providers include one or more cloud providers, hyperscalers, and carriers having worldwide-expanded networks. The one or more service providers, for example, may include multiple service providers that are independently and privately owned and managed. The one or more regional network monitoring systems, in some embodiments, may be configured to communicate within the global administration system using one or more of a Transport Application Programming Interface (T-API) model, a RESTCONF model, and a NETCONF model. The one or more service providers may also be configured to manage Fault, Configuration, Accounting, Performance, and Security (FCAPS) aspects of the multiple domains. The SPOG, for instance, may be configured to provide one or more of a topology view, a service view, performance analysis, alarms, and inventory information of the multiple domains.

### Further Considerations

In some respects, the systems and methods described in the present disclosure may include certain points of novelty and advantages over conventional systems. For instance, the aspect of using domain controllers to interact with each other to achieve a goal of the worldwide enterprise is considered to be novel with respect to traditional systems. Normally, conventional systems would need multiple components from different vendors and service providers. However, the systems and methods of the present disclosure are configured as a “federated” or “global” solution for providing a novel way to achieve a global view much more efficiently. In some respects, another point of novelty lies in the multiple layers of domain controllers being organized in a hierarchical structure to feed monitoring data from lower (e.g., regional) controllers upwards to global controllers to provide consolidated data at the regional controllers.

Also, the present disclosure provides a standardized way of providing an interface to enable controllers to interact with each other. This may enable the flow of data between these devices to meet the needs of an enterprise for global visualization as well as to reduce costs and complexity.

In one use case, the architecture and solutions of the whole network (e.g., the systems and methods described in the present disclosure) may be monitored, managed, and/or controlled by a network orchestrator or administrator that may act on behalf of third party customers (e.g., large-scale service providers). In other words, a company may provide orchestration and/or administration services for global service providers. The network orchestrator or administrator can therefore monitor, manage, and control aspects of networks of a large-scale global customer using the systems and methods of the present disclosure. In turn, the global service providers may be provisioned with a SPOG display that shows the current status of their networks and domains. The global service providers can then visualize their networks globally from the SPOG view that may be applicable to many scenarios and business cases.

### Abstraction Layer

Again, existing network management architectures lack the capability to deliver real-time, comprehensive visibility and control over geographically dispersed and multi-layer network environments, particularly when those environments involve disparate service providers, submarine links, and complex domain-specific protocols. This fragmentation creates technical challenges such as inconsistent data formats, data isolation among different service providers, and difficulty correlating performance metrics from various layers (Layer 0 through Layer 3 or higher) of the OSI stack. The disclosed systems and methods solve these problems by deploying a hierarchical, federated “global administration system” (system) that integrates with multiple regional network monitoring systems and underlying domain controllers via standardized interfaces (e.g., T-API, RESTCONF, NETCONF).

Through the use of abstraction layers, the system conceals the technical complexities of local network management systems and enforces secure interactions between differently managed networks. The global administration system consolidates performance monitoring information—such as GSNR, ESNR, FEC, BER, etc.—across terrestrial and submarine domains into a Single Pane of Glass (SPOG) display for a global operator. In doing so, it enables end-to-end visibility, streamlined troubleshooting, and dynamic configuration control across heterogeneous network infrastructures. This innovative architecture achieves a technical improvement by allowing network operators to access and manage large-scale, globally distributed network resources from a unified dashboard, thereby reducing operational overhead, improving reliability, and significantly enhancing the speed and agility of network administration.

The abstraction layer provides a standardized, model-driven method to normalize, filter, and secure data and control operations between local network management systems and a global administration system. First, it performs data normalization by converting vendor-specific formats into universally recognized data models such as T-API, YANG, OpenConfig, RESTCONF, or NETCONF. In practice, the abstraction layer houses translation adapters that convert raw metrics like GSNR, ESNR, FEC, and BER from various proprietary device interfaces into these standardized representations. This ensures that the global administration system is shielded from the complexities of each vendor's data structures, allowing it to retrieve and display performance statistics, fault data, and configuration parameters in a uniform manner.

Beyond normalization, the abstraction layer also enforces hierarchical control and data filtering to manage what information is shared from local domain controllers up to regional and global systems. This includes aggregating and summarizing raw telemetry to reduce data volume, thereby transmitting only essential alerts, threshold exceptions, or consolidated analytics upstream. Such filtered reporting maintains regulatory compliance and respects service provider confidentiality. By applying role-based access controls and encrypted channels for communications, the abstraction layer enforces security, ensuring that only authorized commands and data flows move between differently managed networks.

When the global or regional layer needs to reconfigure devices, the abstraction layer translates high-level intent—such as a request to reroute traffic or adjust optical power—into vendor-specific commands. Any conflicts, such as resource oversubscription or policy violations, are handled within the abstraction layer before local systems are affected. This mechanism allows global operators to push commands down through multiple service provider domains without directly exposing sensitive proprietary control logic or requiring in-depth knowledge of each local network's unique management protocols.

Moreover, the abstraction layer integrates seamlessly with jump servers to traverse security boundaries. These jump servers ensure that local network segments remain isolated from direct global connections, mitigating risks from external threats. An example workflow begins with local controllers gathering performance data from devices in different layers of the network. The abstraction layer converts these data points into standardized models and shares them securely with the global administration system. The global system, in turn, aggregates the resulting information in a single, unified view, allowing operators to detect issues, send configuration changes back down, and obtain near-real-time feedback on provisioning or fault remediation.

This architecture has several technical advantages. By offloading vendor-specific translations to localized adapters, scalability is enhanced, and new protocols or equipment can be integrated simply by writing new adapters. Consistency is maintained through standardized data models, enabling meaningful comparisons across different domains and transport layers. Security remains robust because local policies, regulatory constraints, and data sovereignty requirements are enforced within the abstraction layer itself, preventing unauthorized or unintended disclosures. Ultimately, this approach provides truly end-to-end visibility and control, spanning photonic Layer 0 equipment to Layer 3 routing, all within a single management framework.

### Conclusion

As used in the present specification and claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A system comprising:
one or more regional network monitoring systems for monitoring multiple domains serviced by one or more service providers of a service provider network;
multiple domain controllers distributed within the multiple domains, the multiple domain controllers configured to modify configuration settings of one or more network elements within each domain; and
a global network monitoring system comprising:
an input/output device configured to display information to a user;
a processing device; and
memory configured to store computing logic having instructions for enabling the processing device to perform steps of
receiving data from the one or more regional network monitoring systems,
consolidating the data to create a Single Pane of Glass (SPOG) showing a global view of the global service provider network, and
displaying the SPOG on the input/output device.

2. The system of claim 1, wherein the SPOG is configured as a User Interface (UI) or dashboard allowing the user to have end-to-end global visibility into enterprise-wide sources of data.

3. The system of claim 1, wherein the instructions further enable the processing device to permit the user to utilize the SPOG to gain federated control over the domains and services of the global service provider network.

4. The system of claim 1, wherein each regional network monitoring system is configured to obtain data by monitoring the one or more network elements within each of the multiple domains.

5. The system of claim 1, wherein the one or more service providers share multiple resources and are separately managed.

6. The system of claim 1, wherein the system is a service orchestration system configured in a Network Operations Center (NOC) or Network Management System (NMS).

7. The system of claim 1, further comprising one or more abstraction layers associated with the one or more service providers, each of the one or more abstraction layers configured to separate and hide details of a network management system or local network monitoring system with respect to a corresponding regional network monitoring system.

8. The system of claim 1, further comprising one or more abstraction layers associated with the one or more service providers, wherein the one or more abstraction layers are configured to interact between multiple different service providers for providing security between the multiple different service providers and to maintain a global instance for managing the global service provider network.

9. The system of claim 1, wherein the global service provider network includes a mix of terrestrial equipment and submarine equipment, the submarine equipment including one or more of a Submarine Line Terminal (SLT), a Point of Presence (PoP) device, a Cable Landing Station (CLS), and a third-party wet plant controller.

10. The system of claim 1, wherein the global service provider network includes Network Elements (NEs) configured within the multiple domains in Layer 0 (photonic layer), Layer 1 (physical layer), Layer 2 (data link layer), or Layer 3 (network layer).

11. The system of claim 1, wherein the data includes one or more of Generalized Signal to Noise Ratio (GSNR) data, Effective Signal to Noise Ratio (ESNR) data, Forward Error Correction (FEC) data, Bit Error Rate (BER) data, and High Correction Count Seconds (HCCS) data.

12. The system of claim 1, wherein the one or more service providers include one or more of cloud providers, hyperscalers, and carriers having worldwide-expanded networks.

13. The system of claim 1, wherein the one or more service providers include multiple service providers that are independently and privately owned and managed.

14. The system of claim 1, wherein the one or more regional network monitoring systems are configured to communicate within the system using one or more of a Transport Application Programming Interface (T-API) model, a RESTCONF model, and a NETCONF model.

15. The system of claim 1, wherein the one or more service providers are configured to manage Fault, Configuration, Accounting, Performance, and Security (FCAPS) aspects of the multiple domains.

16. The system of claim 1, wherein the SPOG is configured to provide one or more of a topology view, a service view, performance analysis, alarms, and inventory information of the multiple domains.

17. A method comprising steps of:
receiving data from one or more regional network monitoring systems distributed globally for monitoring multiple domains serviced by one or more service providers of a global service provider network;
consolidating the data to create a Single Pane of Glass (SPOG) showing a global view of the global service provider network; and
displaying the SPOG on a display screen of a global administrator device.

18. The method of claim 17, further comprising a step of granting end-to-end global visibility into enterprise-wide sources of data to a user of the global administrator device via a User Interface (UI) or dashboard associated with the SPOG.

19. The method of claim 17, further comprising a step of permitting a user of the global administrator device to utilize the SPOG to gain federated control over the domains and services of the global service provider network.

20. A non-transitory computer-readable medium storing instructions that, when executed, cause one or more processors to implement steps of:
receiving data from one or more regional network monitoring systems distributed globally for monitoring multiple domains serviced by one or more service providers of a global service provider network;
consolidating the data to create a Single Pane of Glass (SPOG) showing a global view of the global service provider network; and
displaying the SPOG on a display screen of a global administrator device.
